(19) United States
(12) Patent Application Publication
(10) Pub. No.: US 2014/0229534 A1
(43) Pub. Date: Aug. 14, 2014

(54) METHOD AND SYSTEM FOR ACCESSING MICRO-BLOG ALBUM AND MICRO-BLOG CLIENT

(71) Applicant: Tencent Technology (Shenzhen) Company Limited, Shenzhen (CN)

(72) Inventors: Sheng CAO, Shenzhen (CN); Bo HUANG, Shenzhen (CN); Wei WU, Shenzhen (CN); Ziming WANG, Shenzhen (CN); Jun ZHANG, Shenzhen (CN); Qiong WANG, Shenzhen (CN); Huaheng FAN, Shenzhen (CN); Mengguang LIN, Shenzhen (CN); Yuxiang FAN, Shenzhen (CN)

(73) Assignee: Tencent Technology (Shenzhen) Company Limited, Shenzhen (CN)

(21) Appl. No.: 14/253,594

(22) Filed: Apr. 15, 2014

Related U.S. Application Data
(63) Continuation of application No. PCT/CN2013/076333, filed on May 28, 2013.

(30) Foreign Application Priority Data
May 28, 2012 (CN) 201210168246.0

(51) Int. Cl. H04L 29/06

(52) U.S. Cl. CPC H04L 67/42
USPC 709/203

(57) ABSTRACT

A method and system for accessing a micro-blog album is provided. The method comprises: a micro-blog client receives a micro-blog album viewing request message entered by a user which carries an identifier, sends the micro-blog album viewing request message to a micro-blog server; the micro-blog client receives a micro-blog message corresponding to the identifier fed back by the micro-blog server; the micro-blog client obtains pictures according to the picture link address carried by the micro-blog message from the micro-blog server, generates a micro-blog album according to all the obtained pictures, and display the micro-blog album. The solution of the present invention could centrally display the historical pictures uploaded by the user through the micro-blog client.

### CROSS REFERENCE TO RELATED APPLICATIONS

This application is a continuation application of PCT Application PCT/CN2013/076333 filed on May 28, 2013 claiming a priority from Chinese Application No. 201210168246.0 filed on May 28, 2012. The aforementioned patent applications are hereby incorporated by reference in their entirety.

### FIELD OF THE TECHNOLOGY

The present disclosure relates to the field of data communication and, in particular, to a method and system for accessing a micro-blog album and a micro-blog client.

### BACKGROUND

Currently, micro-blog users publish more and more pictures on micro-blogs, the way of publishing pictures becomes more and more convenient, the demand for sharing pictures increases constantly, and many picture resources have been accumulated in the micro-blogs. Pictures could deliver much richer information than text, and the “era of picture-reading” is approaching. How to centrally display the pictures scattered in the micro-blogs, such that users could quickly view the micro-blog pictures published by themselves or by others, has become an urgent problem to be solved.

The micro-blog business includes web micro-blog and client micro-blog, and both of them are described below, respectively, regarding how to centrally view micro-blog pictures.

Regarding the web micro-blog, the server gathers the pictures in the micro-blogs published by users, respectively, attaches the gathered pictures in the form of an album to a webpage and, then, sends the webpage of the micro-blog to the user terminal for display.

Regarding the client micro-blog, a micro-blog client is installed in a user terminal, and after the user logs in via the micro-blog client, the server feeds micro-blog message back to the micro-blog client for display. The client micro-blog is often used for a mobile terminal, and since the display screen of a mobile terminal is small, the operation is concise, and the traffic is limited. Currently, a client micro-blog only provides the function to display the micro-blog message containing pictures, rather than centrally display historical pictures uploaded by the users.

However, in practice, it is often needed to centrally display the historical pictures uploaded by users through the micro-blog client to meet the users' demand. The web micro-blog performs information interaction in the manner of the webpage, which differs from the implementation of the micro-blog client, and therefore, the technique for centrally displaying the pictures in the web micro-blog cannot be applied directly to the client. How to centrally display users' pictures through a micro-blog client has become a urgent problem to be solved.

### SUMMARY

Embodiments of the present invention provide a method for accessing a micro-blog album, and the method can centrally display historical pictures uploaded by users through a micro-blog client.

Embodiments of the present invention also provide a system for accessing a micro-blog album, and the system can centrally display historical pictures uploaded by users through the micro-blog client.

Embodiments of the present invention also provide a micro-blog client, and the micro-blog client can centrally display historical pictures uploaded by the users.

A method for accessing a micro-blog album, comprising:

receiving, by a micro-blog client, a micro-blog album viewing request message, and sending the micro-blog album viewing request message to a micro-blog server, wherein the micro-blog album viewing request message carries an identifier;

receiving, by the micro-blog client, a micro-blog message corresponding to the identifier fed back by the micro-blog server;

obtaining, by the micro-blog client, pictures according to a picture link address carried by the micro-blog message from the micro-blog server;

typesetting and generating, by the micro-blog client, an album according the obtained pictures, and displaying the album.

A system for accessing a micro-blog album, comprising a micro-blog client and a micro-blog server, wherein

the micro-blog client is configured to receive a micro-blog album viewing request message, send the micro-blog album viewing request message to the micro-blog server, wherein the micro-blog album viewing request message carries an identifier, receive a micro-blog message corresponding to the identifier fed back by the micro-blog server, obtain pictures according to a picture link address carried by the micro-blog message from the micro-blog server, typeset and generate an album according to the obtained pictures and display the album;

the micro-blog server is configured to receive the micro-blog album viewing request message from the micro-blog client, extract the micro-blog message corresponding to the identifier, and feed back the micro-blog message to the micro-blog client.

A micro-blog client, comprising an album requesting unit, a micro-blog message receiving unit, a picture obtaining unit and a picture displaying unit, wherein

the album requesting unit is configured to receive a micro-blog album viewing request message, send the micro-blog album viewing request message to a micro-blog server, wherein the micro-blog album viewing request message carries an identifier;

the micro-blog message receiving unit is configured to receive a micro-blog message corresponding to the identifier fed back by the micro-blog server, and send the micro-blog message to the picture obtaining unit;

the picture obtaining unit is configured to obtain pictures according to a picture link address carried by the micro-blog message from the micro-blog server, and send the obtained pictures to the picture displaying unit;

the picture displaying unit is configured to typeset and generate an album according to the obtained pictures and display the album.

It can be seen from the above solutions, in the present invention, when it is necessary, the micro-blog client obtains the micro-blog message corresponding to the identifier from the micro-blog server, then obtains pictures from the micro-blog server according to the picture link address in the micro-blog message, then generates a micro-blog album including all the obtained pictures, and displays the micro-blog album. Therefore, centrally displaying the historical pictures uploaded by the user through the micro-blog client is achieved, and the user's demand is met.

### BRIEF DESCRIPTION OF THE DRAWINGS

FIG. 1 is a schematic flow chart of a method for accessing a micro-blog album according to an embodiment of the present invention;

FIG. 2 is an example of a micro-blog album and an enlarged picture displayed on a micro-blog client according to an embodiment of the present invention;

FIG. 3 is an example of a flow chart of a method for accessing a micro-blog album according to an embodiment of the present invention;

FIG. 4 is a structural diagram of a system for accessing a micro-blog album according to an embodiment of the present invention.

### DETAILED DESCRIPTION OF THE EMBODIMENTS

In order to make the objects, technical solutions and merits of the present invention clearer, the following describes the present invention in detail with reference to accompanying drawings and embodiments.

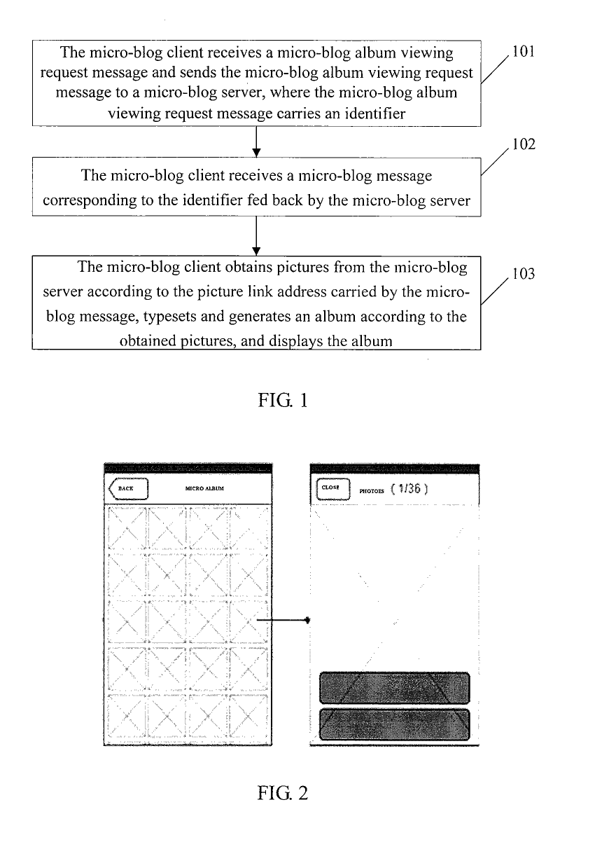

FIG. 1 is a schematic flow chart of a method for accessing a micro-blog album according to an embodiment of the present invention, and the method includes the following steps.

Step 101, the micro-blog client receives a micro-blog album viewing request message and sends the micro-blog album viewing request message to a micro-blog server, where the micro-blog album viewing request message carries an identifier.

Specifically, the identifier is a user identifier, such as an account for logging in the micro-blog.

Receiving, by the micro-blog client, the micro-blog album viewing request message which carries the identifier entered by a user can be implemented by setting one or more function keys of micro-blog album in a user interface, and each of the function keys corresponds to a different identifier. Once the user clicks on a key corresponding to a certain identifier, the micro-blog client will know that the user enters a micro-blog album viewing request message carrying the certain identifier. The identifier corresponding to the function key of the micro-blog album can be an identifier of an active user who is logging in the micro-blog client, so as to obtain the micro-blog album of the active user; or an identifier of a friend of the active user, so as to obtain the micro-blog album of the friend of the active user.

After receiving the micro-blog album viewing request message from the micro-blog client, the micro-blog server can feed back all the micro-blog messages corresponding to the identifier to the micro-blog client.

A user's original micro-blog pictures get more attention, through which the first impression perception about the user can be formed more quickly. Therefore, after the micro-blog server receives the micro-blog album viewing request message from the micro-blog client, the micro-blog server obtains all the micro-blog messages corresponding to the identifier, filters out micro-blog messages not composed by the user, and feeds back merely micro-blog messages composed by the user to the micro-blog client. Whether the micro-blog message is composed by the user can be determined in accordance with the types of the micro-blog messages. For example, if the type is forwarding, the micro-blog message is not composed by the user, and if the type is posting, the micro-blog message is composed by the user.

Step 102, the micro-blog client receives a micro-blog message corresponding to the identifier fed back by the micro-blog server.

In practice, the micro-blog server stores the micro-blog messages of each user corresponding to an identifier, and stores the micro-blog messages and pictures separately. The micro-blog messages contain no picture, but contain a picture link address. According to embodiments of the present invention, the micro-blog server receives the micro-blog album viewing request message carrying an identifier, obtains the corresponding micro-blog messages according to the identifier, and feeds back the micro-blog messages to the micro-blog client. Specifically, the picture link address refers to an Uniform Resource Locator (URL) address of the pictures, for example.

Step 103, the micro-blog client obtains pictures from the micro-blog server according to the picture link address carried by the micro-blog message, typesets and generates an album according to the obtained pictures, and displays the album.

Obtaining, by the micro-blog client, pictures from the micro-blog server according to the picture link address carried by the micro-blog message can specifically include:

sending, by the micro-blog client, a first picture obtaining request carrying information of screen size of the micro-blog client and the picture link address to the micro-blog server;

performing, by the micro-blog server, an addressing operation according to the picture link address carried by the first picture obtaining request to find stored pictures corresponding to the picture link address, extracting, from the stored pictures, pictures satisfying a size as indicated by the information of screen size of the micro-blog client, and feeding back the extracted pictures to the micro-blog client.

The micro-blog server stores multiple pictures in different sizes. After finding the corresponding pictures through addressing operation, the micro-blog server feeds back the pictures satisfying the screen size of the micro-blog client to the micro-blog client. A micro-blog album simultaneously displays multiple pictures, and the permutation and combination of the pictures in the micro-blog album can be set as desired. For example, the micro-blog album transversely displays three or four pictures. FIG. 2 is an example of displaying four pictures transversely. In particular, the pictures in the micro-blog album can be arranged according to time sequence.

After the micro-blog album is displayed, a certain picture in the micro-blog album can be enlarged for displaying. Specifically, when necessary, the user clicks on a certain picture in the micro album, each picture corresponds to a picture link address thereof, and thus, a picture enlarge-display request carrying a certain picture link address is received by the micro-blog client upon the click. And then, the micro-blog client sends a second picture obtaining request carrying an enlarged size and the picture link address to the micro-blog server.

The micro-blog server performs an addressing operation according to the picture link address carried by the second picture obtaining request to find stored pictures corresponding to the picture link address carried by the second picture obtaining request, extracts a picture satisfying the enlarged size, and feeds back the picture satisfying the enlarged size to the micro-blog client for displaying.

The micro-blog client determines the enlarged size according to the screen size of the user terminal in which the micro-blog client is installed, then sends the determined enlarged size contained in a picture obtaining request to the micro-blog server; the micro blog server stores multiple pictures in different sizes. After finding the corresponding pictures through addressing operation, the micro-blog server feeds back the picture satisfying the enlarged size to the micro-blog client; the micro-blog client displays the received picture. As shown in the example of FIG. 2, the first picture in the micro-blog album is displayed in enlarged size.

After sending the pictures satisfying the enlarged size back to the micro-blog client for displaying, the method further includes: receiving, by the micro-blog client, a micro-blog message displaying request input by the user which carries a picture link address, extracting micro-blog text content corresponding to the picture link address carried by the micro-blog message displaying request from the micro-blog message fed back by the micro-blog server in step 102, and displaying the micro-blog text content together with the enlarged pictures. Specifically, the micro-blog message can be displayed by overlapping on the enlarged pictures currently displayed. Overlap-displaying the specified message on the picture is a prior art, which is not repeated herein. As shown in the example of FIG. 2, the first picture in the micro-blog album is displayed in enlarged size, and the micro-blog message corresponding to the picture is displayed by overlapping on the enlarged picture, wherein the gray part at the bottom of the picture is the displaying area for the micro-blog message.

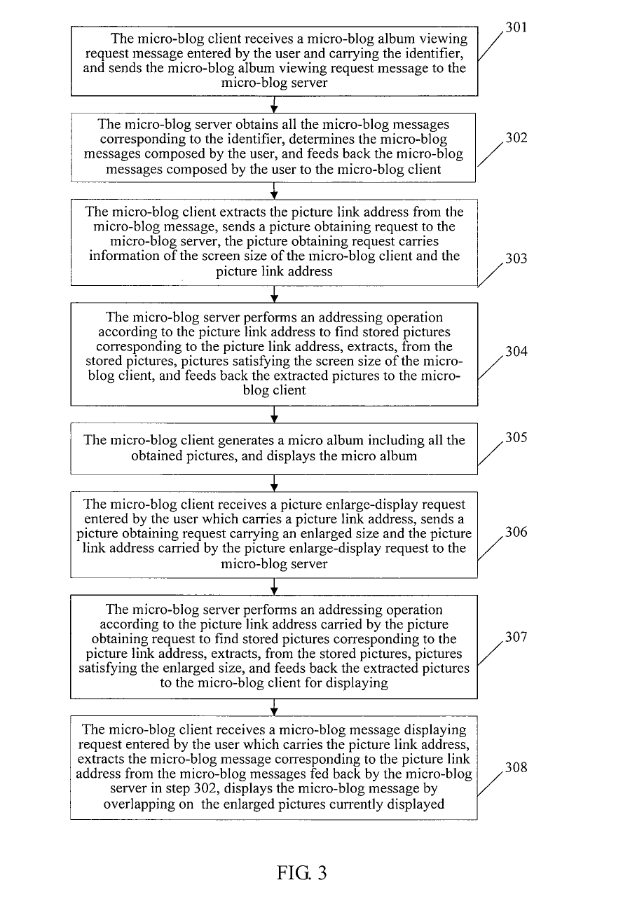

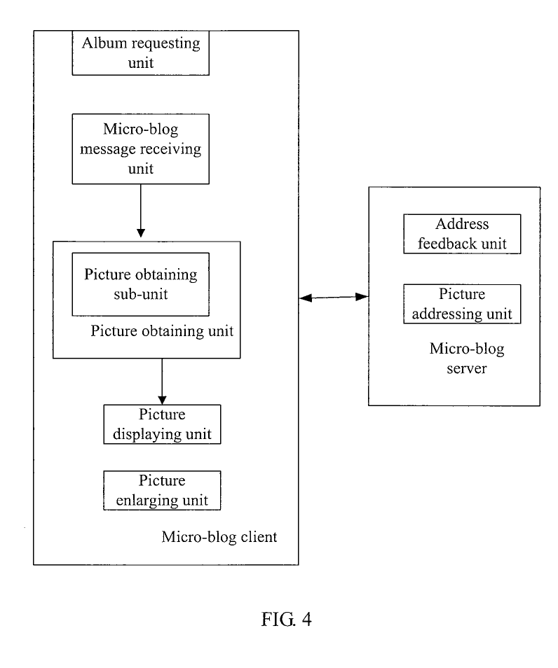

With reference to the example shown in FIG. 3, the following describes the method for accessing the micro-blog album in detail according to an embodiment of the present invention, which includes the following steps.

Step 301, the micro-blog client receives a micro-blog album viewing request message entered by the user and carrying the identifier, and sends the micro-blog album viewing request message to the micro-blog server.

Step 302, the micro-blog server obtains all the micro-blog messages corresponding to the identifier, determines the micro-blog messages composed by the user, and feeds back the micro-blog messages composed by the user to the micro-blog client.

Step 303, the micro-blog client extracts the picture link address from the micro-blog message, sends a picture obtaining request to the micro-blog server, the picture obtaining request carries information of the screen size of the micro-blog client and the picture link address;

Step 304, the micro-blog server performs an addressing operation according to the picture link address to find stored pictures corresponding to the picture link address, extracts, from the stored pictures, pictures satisfying the screen size of the micro-blog client, and feeds back the extracted pictures to the micro-blog client.

Step 305, the micro-blog client generates a micro-blog album including all the obtained pictures, and displays the micro album.

Step 306, the micro-blog client receives a picture enlarge-display request entered by the user which carries a picture link address, sends a picture obtaining request carrying an enlarged size and the picture link address carried by the picture enlarge-display request to the micro-blog server.

Step 307, the micro-blog server performs an addressing operation according to the picture link address carried by the picture obtaining request to find stored pictures corresponding to the picture link address, extracts, from the stored pictures, pictures satisfying the enlarged size, and feeds back the extracted pictures to the micro-blog client for displaying.

Step 308, the micro-blog client receives a micro-blog message displaying request entered by the user which carries the picture link address, extracts the micro-blog message corresponding to the picture link address from the micro-blog messages fed back by the micro-blog server in step 302, displays the micro-blog message by overlapping on the enlarged pictures currently displayed.

In the present invention, when necessary, the micro-blog client obtains the micro-blog message corresponding to the identifier from the micro-blog server, obtains pictures from the micro-blog server according to the picture link address in the micro-blog message, then generates a micro-blog album including all the obtained pictures, and displays the micro album. Therefore, centrally displaying the historical pictures uploaded by the user through the micro-blog client is achieved, and the user's demand is met.

Refer to FIG. 4, it is a structural diagram for a system for accessing the micro-blog album according to an embodiment of the present invention. The system includes a micro-blog client and a micro-blog server.

The micro-blog client is configured to receive a micro-blog album viewing request message, send the micro-blog album viewing request message to the micro-blog server, wherein the micro-blog album viewing request message carries an identifier; receive a micro-blog message corresponding to the identifier fed back by the micro-blog server, obtain pictures according to a picture link address carried by the micro-blog message from the micro-blog server, typeset and generate an album according to the obtained pictures and display the album.

The micro-blog server is configured to receive the micro-blog album viewing request message from the micro-blog client, extract the micro-blog message corresponding to the identifier, and feed back the micro-blog message to the micro-blog client.

Optionally, the micro-blog client includes an album requesting unit, a micro-blog message receiving unit, a picture obtaining unit and a picture displaying unit, and the micro-blog server includes an address feedback unit.

The album requesting unit is configured to receive the micro-blog album viewing request message, send the micro-blog album viewing request message to the micro-blog server, wherein the micro-blog album viewing request message carries an identifier.

The micro-blog message receiving unit is configured to receive the micro-blog message corresponding to the identifier fed back by the micro-blog server, and send the micro-blog message to the picture obtaining unit.

The picture obtaining unit is configured to obtain pictures according to a picture link address carried by the micro-blog message from the micro-blog servicer, and send the obtained pictures to the picture displaying unit.

The picture displaying unit is configured to typeset and generate the album according to the obtained pictures and display the album.

The address feedback unit is configured to receive the micro-blog album viewing request message, obtain the micro-blog message corresponding to the identifier, and feed back the micro-blog message to the album requesting unit.

Optionally, the picture obtaining unit includes a picture obtaining sub-unit, and the micro-blog server further includes a picture addressing unit.

The picture acquiring sub-unit is configured to send a first picture obtaining request carrying information of screen size of the micro-blog client and the picture link address to the picture addressing unit, and receive the pictures fed back by the picture addressing unit.

The picture addressing unit is configured to receive the first picture obtaining request sent by the picture obtaining sub-unit, perform an addressing operation according to the picture link address carried by the first picture obtaining request to find stored pictures corresponding to the picture link address, extract, from the stored pictures, pictures satisfying the size as indicated by the information of screen size of the micro-blog client, and feed back the extracted pictures to the picture obtaining sub-unit.

Optionally, the micro-blog client further includes a picture enlarging unit, configured to receive a picture enlarge-display request entered by a user which carries a picture link address, send a second picture obtaining request carrying an enlarged size and the picture link address carried by the picture enlarge-display request to the picture addressing unit, receive a picture fed back by the picture addressing unit and display in the enlarged size.

The picture addressing unit is also configured to receive the second picture obtaining request sent by the picture enlarging unit, perform an addressing operation according to the picture link address carried by the second picture obtaining request to find stored pictures corresponding to the picture link address carried by the second picture obtaining request, extract, from the stored pictures, a picture satisfying the enlarged size, and feed back the picture satisfying the enlarged sized to the picture enlarging unit.

The solutions of the present invention are adopted to view a user's micro-blog pictures at a micro-blog client in the manner similar to an album, so as to quickly learn the historical pictures published by the user on the micro-blog, which accelerates the understanding of the user by reading pictures, and greatly improves the loyalty and experience of micro-blog users.

The above embodiments are merely provided for describing the technical solutions of the present invention, but not intended to limit the present invention. It should be understood that, any modifications, equivalent replacements or improvements made within the spirit and scope of the present invention shall fall within the protection scope of the present invention.

1. A method for accessing a micro-blog album, comprising:
receiving, by a micro-blog client, a micro-blog album viewing request message, and sending the micro-blog album viewing request message to a micro-blog server, wherein the micro-blog album viewing request message carries an identifier;
receiving, by the micro-blog client, a micro-blog message corresponding to the identifier fed back by the micro-blog server;
obtaining, by the micro-blog client, pictures from the micro-blog server according to a picture link address carried by the micro-blog message;
typesetting and generating, by the micro-blog client, an album according the obtained pictures, and displaying the album.

2. The method according to claim 1, wherein the identifier is a user identifier, and
the receiving, by the micro-blog client, the micro-blog message corresponding to the identifier fed back by the micro-blog server comprises:
obtaining, by the micro-blog server, all micro-blog messages corresponding to the user identifier; and
filtering out, by the micro-blog server, micro-blog messages not composed by a user corresponding to the user identifier, and feeding back only micro-blog messages composed by the user to the micro-blog client.

3. The method according claim 2, wherein the user identifier is an identifier of an active user logging in the micro-blog client, or an identifier of a friend of the active user logging in the micro-blog client.

4. The method according to claim 1, wherein the obtaining, by the micro-blog client, the pictures from the micro-blog server according to the picture link address carried by the micro-blog message comprises:
sending, by the micro-blog client, a first picture obtaining request carrying information of screen size of the micro-blog client and the picture link address to the micro-blog server;
performing, by the micro-blog server, an addressing operation according to the picture link address carried by the first picture obtaining request to find stored pictures corresponding to the picture link address, extracting, from the stored pictures, pictures satisfying a size as indicated by the information of screen size of the micro-blog client, and feeding back the extracted pictures to the micro-blog client.

5. The method according to claim 4, wherein after the typesetting and generating, by the micro-blog client, the album according the obtained pictures, and displaying the album, the method further comprises:
receiving, by the micro-blog client, a picture enlarge-display request entered by a user, and sending a second picture obtaining request to the micro-blog server, wherein the picture enlarge-display request carries the picture link address, and the second picture obtaining request carries an enlarged size and the picture link address carried by the picture enlarge-display request;
performing, by the micro-blog server, an addressing operation according to the picture link address carried by the second picture obtaining request to find stored pictures corresponding to the picture link address carried by the second picture obtaining request, extracting, from the stored pictures, a picture satisfying the enlarged size, and feeding back the picture satisfying the enlarged size to the micro-blog client for displaying.

6. The method according to claim 5, wherein after the feeding back the picture satisfying the enlarged size to the micro-blog client for displaying, the method further comprises:
receiving, by the micro-blog client, a micro-blog message displaying request input by the user, wherein the micro-blog message displaying request carries the picture link address, extracting, from the micro-blog message fed back by the micro-blog server, micro-blog text content corresponding to the picture link address carried by the micro-blog message displaying request, and displaying the micro-blog text content together with the picture satisfying the enlarged size.

7. A system for accessing a micro-blog album, comprising a micro-blog client and a micro-blog server, wherein
the micro-blog client is configured to receive a micro-blog album viewing request message, send the micro-blog album viewing request message to the micro-blog server, wherein the micro-blog album viewing request message carries an identifier, receive a micro-blog message corresponding to the identifier fed back by the micro-blog server, obtain pictures according to a picture link address carried by the micro-blog message from the micro-blog server, typeset and generate an album according to the obtained pictures and display the album;
the micro-blog server is configured to receive the micro-blog album viewing request message from the micro-blog client, extract the micro-blog message corresponding to the identifier, and feed back the micro-blog message to the micro-blog client.

8. The system according to claim 7, wherein the micro-blog client comprises an album requesting unit and a picture obtaining unit, the micro-blog server comprises an address feedback unit, and wherein
the album requesting unit is configured to receive the micro-blog album viewing request message, send the micro-blog album viewing request message to the address feedback unit, receive the micro-blog message returned from the address feedback unit, and send the micro-blog message to the picture obtaining unit;
the picture obtaining unit is configured to obtain the pictures from the micro-blog server according to the picture link address carried by the micro-blog message, typeset and generate the album according to the obtained pictures, and display the album;
the address feedback unit is configured to receive the micro-blog album viewing request message, obtain the micro-blog message corresponding to the identifier, and feed back the micro-blog message to the album requesting unit.

9. The system according to claim 8, wherein the picture obtaining unit comprises a picture obtaining sub-unit, the micro-blog server further comprises a picture addressing unit, and wherein
the picture obtaining sub-unit is configured to send a first picture obtaining request carrying information of screen size of the micro-blog client and the picture link address to the picture addressing unit, and receive the pictures fed back by the picture addressing unit;
the picture addressing unit is configured to receive the first picture obtaining request sent by the picture obtaining sub-unit, perform an addressing operation according to the picture link address carried by the first picture obtaining request to find stored pictures corresponding to the picture link address, extract, from the stored pictures, pictures satisfying a size as indicated by the information of screen size of the micro-blog client, and feed back the extracted pictures to the picture obtaining sub-unit.

10. The system according to claim 9, wherein, the micro-blog client further comprises a picture enlarging unit, configured to receive a picture enlarge-display request entered by a user which carries the picture link address, send a second picture obtaining request carrying an enlarged size and the picture link address carried by the picture enlarge-display request to the picture addressing unit, receive a picture fed back by the picture addressing unit and display in the enlarged size;
the picture addressing unit is also configured to receive the second picture obtaining request sent by the picture enlarging unit, perform an addressing operation according to the picture link address carried by the second picture obtaining request to find stored pictures corresponding to the picture link address carried by the second picture obtaining request, extract, from the stored pictures, a picture satisfying the enlarged size, and feed back the picture satisfying the enlarged size to the picture enlarging unit.

11. A micro-blog client, comprising an album requesting unit, a micro-blog message receiving unit, a picture obtaining unit and a picture displaying unit, wherein
the album requesting unit is configured to receive a micro-blog album viewing request message, send the micro-blog album viewing request message to a micro-blog server, wherein the micro-blog album viewing request message carries an identifier;
the micro-blog message receiving unit is configured to receive a micro-blog message corresponding to the identifier fed back by the micro-blog server, and send the micro-blog message to the picture obtaining unit;
the picture obtaining unit is configured to obtain pictures according to a picture link address carried by the micro-blog message from the micro-blog server, and send the obtained pictures to the picture displaying unit;
the picture displaying unit is configured to typeset and generate an album according to the obtained pictures and display the album.

12. The micro-blog client according to claim 11, wherein the picture obtaining unit comprises a picture obtaining sub-unit, and wherein
the picture obtaining sub-unit is configured to send a first picture obtaining request carrying information of screen size of the micro-blog client and the picture link address to the micro-blog server, and receive the pictures fed back by the micro-blog server.

13. The micro-blog client according to claim 12, wherein the micro-blog client further comprises a picture enlarging unit, configured to receive a picture enlarge-display request entered by a user which carries the picture link address, send a second picture obtaining request carrying an enlarged size and the picture link address carried by the picture enlarge-display request to the micro-blog server, receive a picture fed back by the micro-blog server and display in the enlarged size.
